(19) United States
(12) Patent Application Publication
(10) Pub. No.: US 2015/0010895 A1
(43) Pub. Date: Jan. 8, 2015

(54) PERFORMANCE MANAGEMENT SYSTEMS AND METHODS

(71) Applicant: Perform Yard, Inc., Arlington, VA (US)

(72) Inventors: Benjamin HASTINGS, Manassas, VA (US); Jonathan MALPASS, Washington, DC (US)

(21) Appl. No.: 14/324,923

(22) Filed: Jul. 7, 2014

Related U.S. Application Data
(60) Provisional application No. 61/843,801, filed on Jul. 8, 2013.

(51) Int. Cl. G09B 7/00

(52) U.S. Cl. CPC G09B 7/00
USPC 434/362

(57) ABSTRACT

Performance management systems and methods may utilize a plurality of modules. A performance network module may receive a post from a user and cause the post to be displayed on a display, and receive a comment associated with the post from the user and cause the post to be displayed on the display. A report module may generate a report including a question and send the report to the user, and receive an answer to the question in the report from the user and store the answer in a database. A goal module may receive a goal and/or an update to the goal, and update a status associated with the goal. A review module may generate a review including a question and send the review to the user, and receive an answer to the question in the review from the user and store the answer in the database.

### CROSS-REFERENCE TO RELATED APPLICATIONS

This application is based upon and claims the benefit of priority from Provisional Patent Application 61/843,801, filed Jul. 8, 2013, the entire contents of which are incorporated herein by reference.

### BRIEF DESCRIPTION OF THE DRAWINGS

FIG. 1 is a network according to an embodiment of the invention.

FIG. 2 is a network according to an embodiment of the invention.

FIG. 3 is a performance management process according to an embodiment of the invention.

FIG. 4 is a network interaction process according to an embodiment of the invention.

FIG. 5 is a profile interaction process according to an embodiment of the invention.

FIG. 6 is a status update process according to an embodiment of the invention.

FIG. 7 is a goals update process according to an embodiment of the invention.

FIG. 8 is a review completion process according to an embodiment of the invention.

FIG. 9 is a home page screenshot according to an embodiment of the invention.

FIG. 10 is a user page screenshot according to an embodiment of the invention.

FIG. 11 is a status report screenshot according to an embodiment of the invention.

FIG. 12 is a status edit page screenshot according to an embodiment of the invention.

FIGS. 13a-13b are goals page screenshots according to an embodiment of the invention.

FIGS. 14a-14b are goal detail screenshots according to an embodiment of the invention.

FIG. 15 is a review page screenshot according to an embodiment of the invention.

FIG. 16 is a review edit page screenshot according to an embodiment of the invention.

FIG. 17 is a settings page screenshot according to an embodiment of the invention.

### DETAILED DESCRIPTION OF SEVERAL EMBODIMENTS

Systems and methods described herein may provide interactive performance management features for organizations such as corporations or other businesses. Performance management systems and methods may include a variety of features enabling users such as employees and managers to interact with the performance management system and one another. For example, employees may interact with one another via a performance network limited to users in a single organization/company. A workspace for employees to announce or promote successes and accomplishments, or solicit help and feedback from other users, may be provided. An environment for employees to recognize one another and provide feedback for their work performance may be provided. Employees may be managed through the presentation of data to understand the performance of other employees. A place may be provided for an employee to complete a regular status report on their recent work activities. A workflow may be created for a manager to review an employee's status report. A workspace may be provided for an employee to manage professional goals through identifying, updating, and completing those goals, and communicating those goals to the rest of the organization. An employee and manager may be able to engage in a coaching conversation regarding those goals. A workspace for an employee to complete an self-evaluation as part of a regularly scheduled employee review may be provided; and a space for a manager to review that self-evaluation and to complete a managerial evaluation of that employee as part of a regularly scheduled employee review may also be provided. Summary dashboards, insights, and analytics related to the information submitted by employees for managers and executives to measure success/failure and better understand the “pulse” of the organization may be provided. These and other functions and features of the performance management systems and methods are described in greater detail below.

Systems and methods described herein may comprise one or more computers. A computer may be any programmable machine or machines capable of performing arithmetic and/or logical operations. In some embodiments, computers may comprise processor circuits, memory circuits, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used. For example, though the term “server” may appear in the following specification, the disclosed embodiments are not limited to servers.

Computers may be linked to one another via a network or networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via Wi-Fi, WiMax, or other wireless connection). Connections between computers may use any protocols, including connection oriented protocols such as TCP or connectionless protocols such as UDP. Any connection through which at least two computers may exchange data can be the basis of a network.

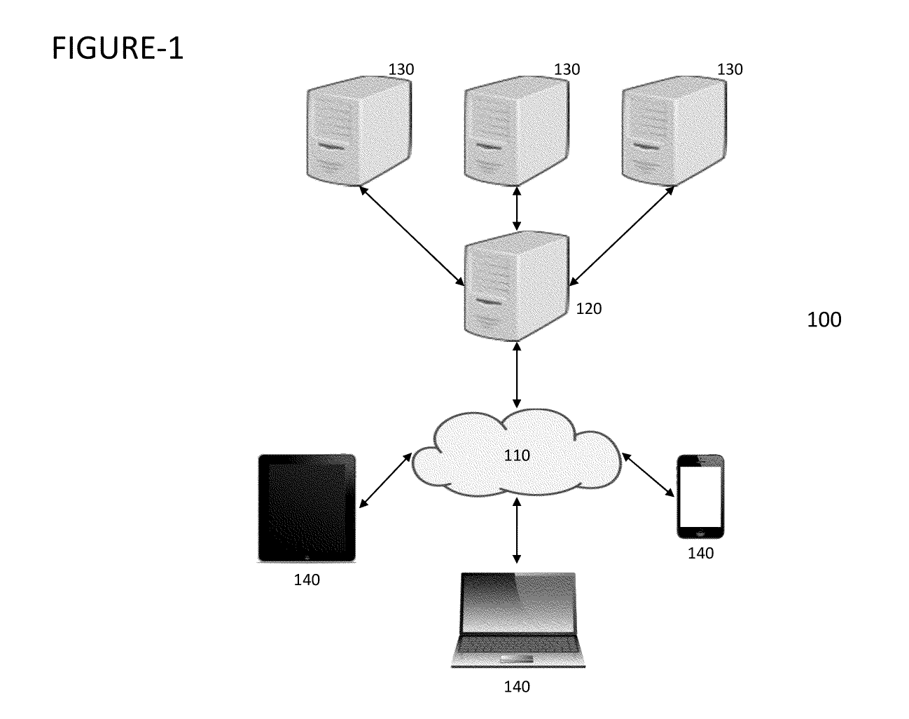

FIG. 1 is a network 100 according to an embodiment of the invention. One or more system servers 120/130 may be in communication with a network such as the Internet 110. In this example, the system servers 120/130 comprise a network interface server 120 which is connected to the Internet 110 and a plurality of back end servers 130, although other configurations may be possible. One or more personal computing devices 140 may also be in communication with the Internet 110. The personal computing devices may be, for example, a personal computer, a smart phone, a tablet computer, or any other device. The system servers 120/130 may link to at least one user accessing one or more software applications on the system servers 120/130 via a personal computing device 140. That device 140 may allow the user to connect to the Internet 110 and access the performance management system on the system servers 120/130. The performance management system described in greater detail below may be hosted by the system servers 120/130 and may be accessed by the personal computing devices 140.

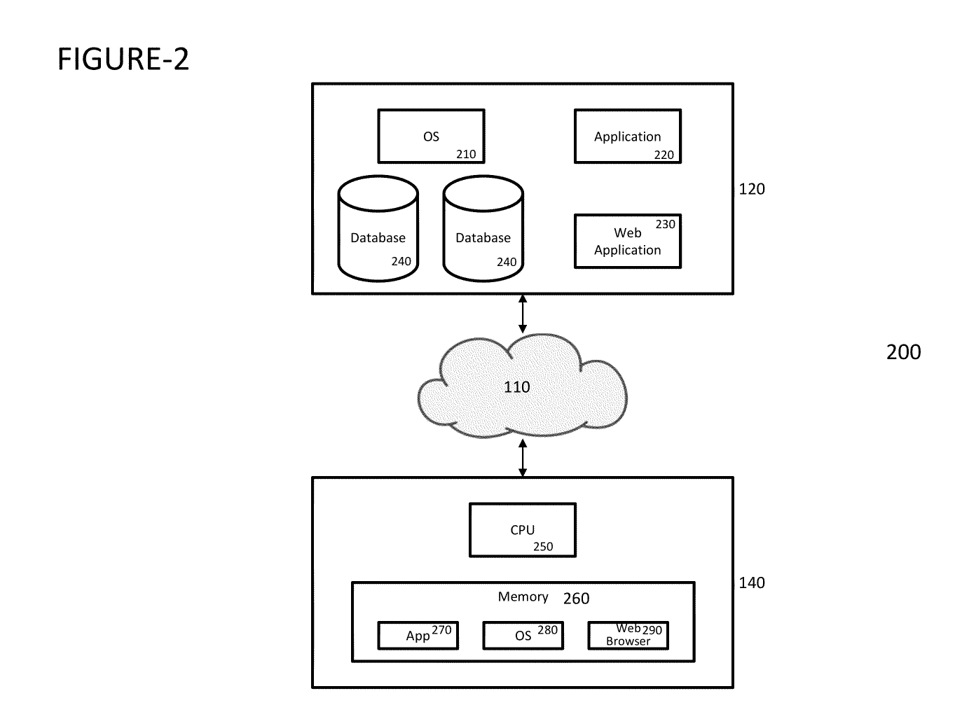

FIG. 2 is a network 200 according to an embodiment of the invention. In this example network 200, one system server 120 and one personal computing device 140 are shown connected to the Internet 110, although other configurations may be possible. The system server 120 may have software for operating the system that includes, but is not limited to, an operating system 210 with communication software for connecting to the Internet 110, drivers, and other software utilities which may enable the server 120 to operate, which is well known to those of ordinary skill in the art. The system server 120 may also have one or a plurality of storage devices 240, including, for example, but not limited to, storage devices for maintaining user account and access information and storing performance information submitted by the user. It is also understood by those of ordinary skill that the system server 120 is not limited to a single device, but can be multiple devices electronically connected and operating together to perform a plurality of functions of the system server, such as in a distributed server network.

The server 120 may also include other application 220 and/or web application 230 components. For example, the server 120 may have a software application 230 connecting to the Internet 110 and serving pages described in greater detail below to the user. A software application 220 of an example embodiment may receive and collect performance information from users connected to the application by the Internet 110.

FIG. 2 also shows a personal computing device 140 associated with a user connected to the performance management system server 120. The personal computing device 140 may have a central processing unit (CPU) 250, memory 260, and software for operating the system that may include, but is not limited to, an operating system 280 with communications software for connecting to the Internet 110 and other software utilities useful for the device to operate which are well known to those of ordinary skill in the art. The personal computing device 140 may have a web browser 290 that, when the device 140 is connected to the Internet 110, may retrieve selected pages from a performance management system website served by the server 120, allowing the user to interact with the server 120 by entering data into the system and displaying the selected pages of the website of the system. The personal computing device 140 may also include other applications 270 for which may be used by a user to interact with the performance management system.

Performance information for various users within a single corporate group may be accessible via the performance management system, combining a performance network where employees interact with one another with a system to manage recurring status reports, employee goals, and employee reviews. The performance network may provide a workspace for users within a corporate group to exchange information, thoughts, opinions, and ideas related to work performance at the user's employer via posts to the performance network. These posts may include such comments as a user providing updates on his/her own individual performance, a user providing performance-related feedback to other users within the corporate group, or a user commenting on other users' postings.

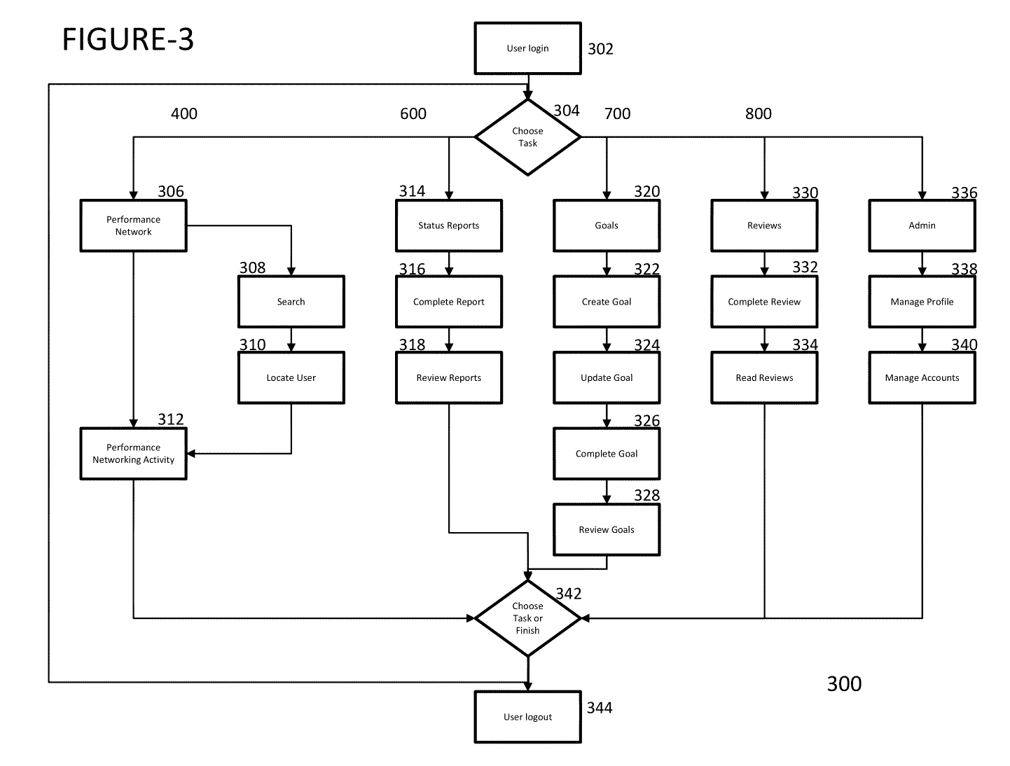

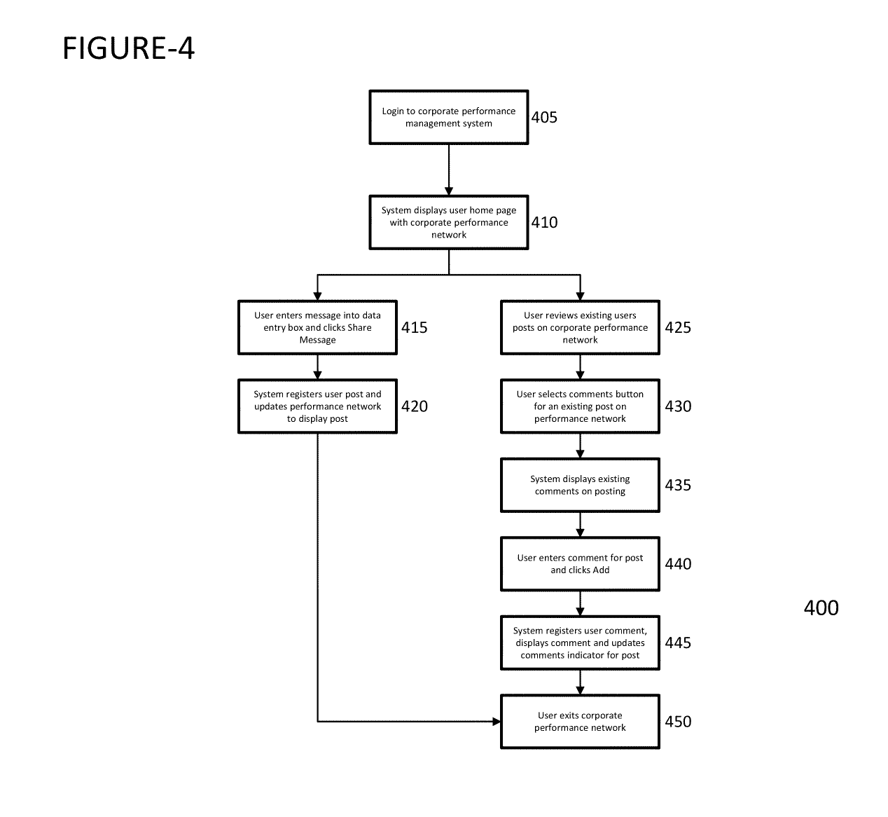

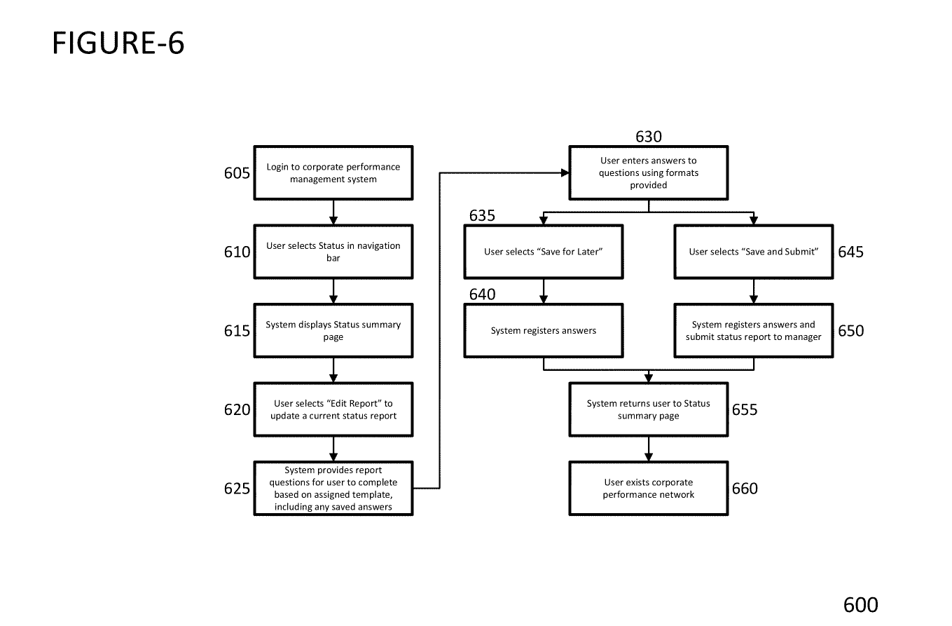

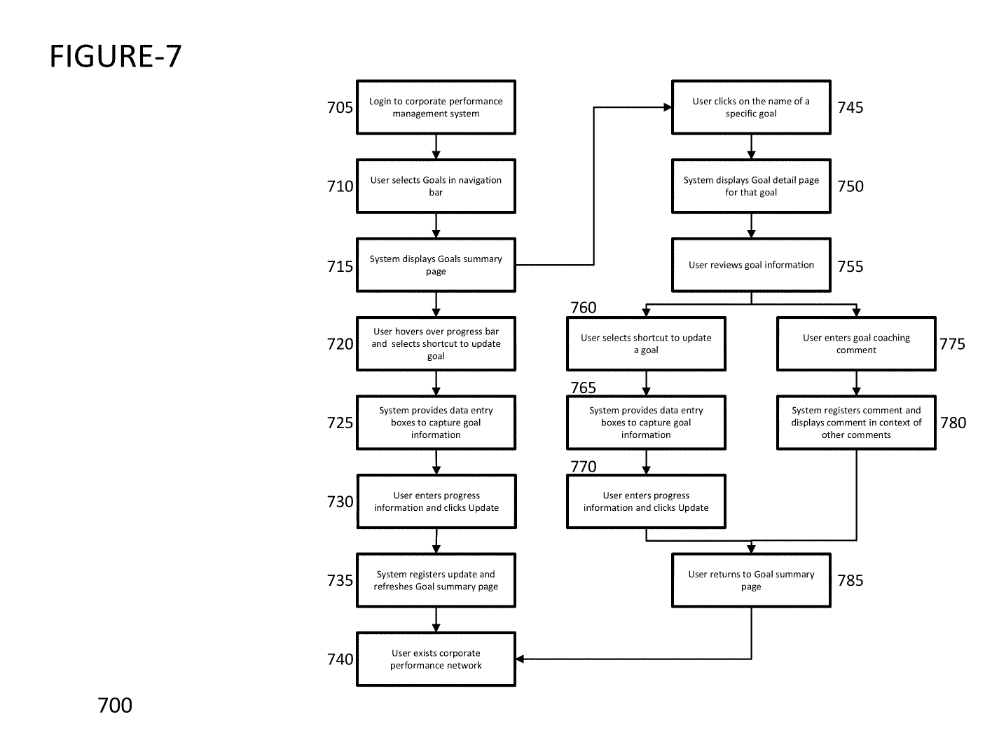

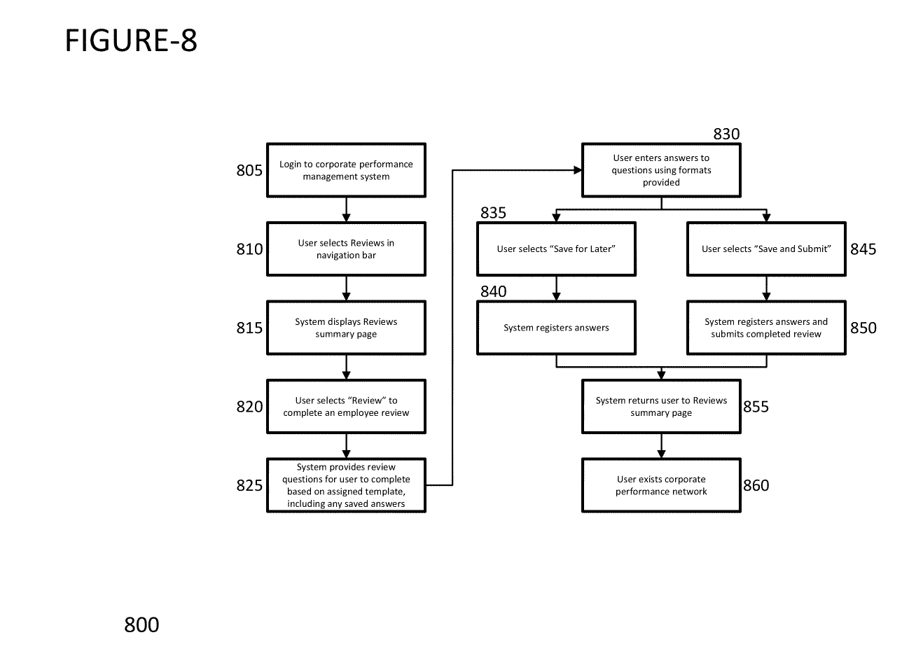

FIG. 3 is a performance management process 300 according to an embodiment of the invention. This process 300 is an overview of a variety of ways in which a user may interact with the performance management system provided by the server 120/130 and personal computing device 140 as described above. The user may visit the website of a corporate performance management system. If the user is a registered member of a corporate group, the user may log into the system 302, for example with an email address and password, to access available functions which may be based on the user's role within the system as defined by administrators that control access to corporate groups. The user may select a task to perform 304 via an interface presented to the user. Tasks may include, for example, adding, reviewing, and/or commenting on posts in the performance network 306 (an example of which is shown in the process 400 of FIG. 4 as described below); completing the user's weekly status report and/or reviewing other status reports 314 (an example of which is shown in the process 600 of FIG. 6 as described below); creating, managing, and/or updating the user's goals 320 (an example of which is shown in the process 700 of FIG. 7 as described below); and/or completing and/or reading reviews of users 330 (an example of which is shown in the process 800 of FIG. 8 as described below). The system may allow the user to move between these tasks using a navigation menu bar or other interface. If the user is an admin user, the user may also be able to access admin functions 336.

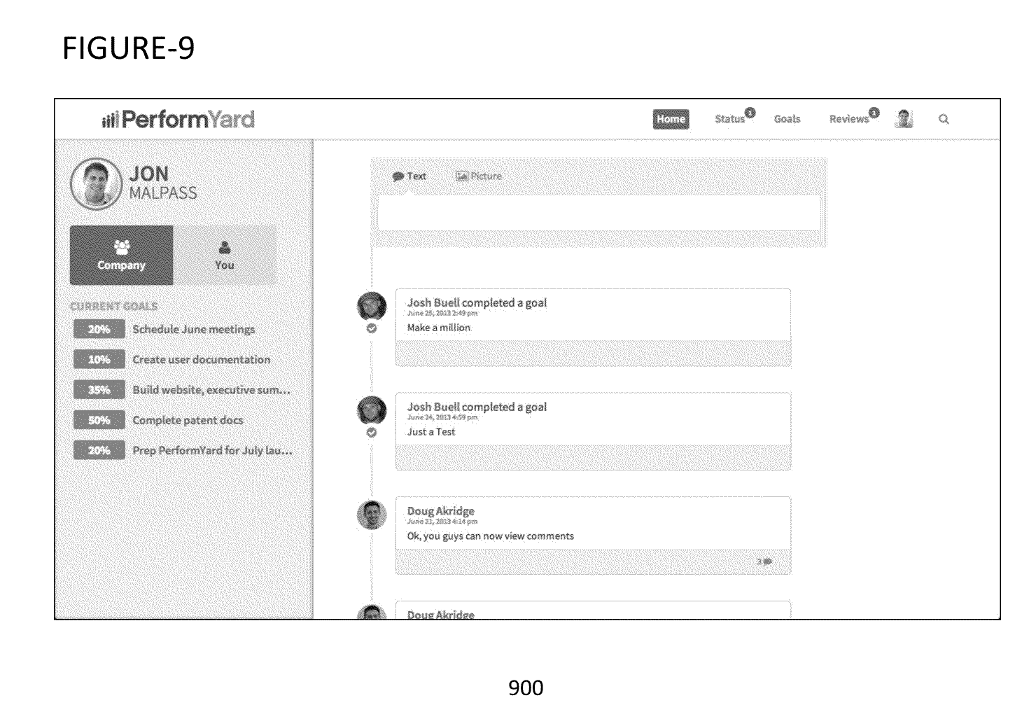

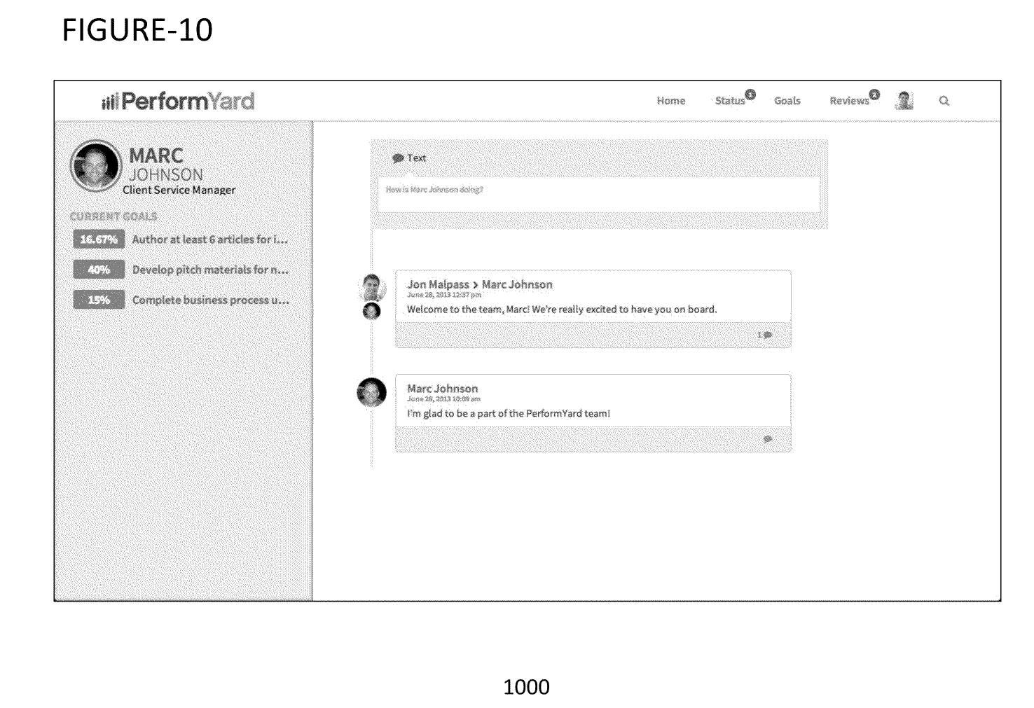

For example, the user may participate in the corporate performance network 306. Upon login, the user may view his/her home screen that displays summary performance information for the user along with the posts in the corporate performance network. See FIG. 9, described in greater detail below, for an example home screen. The user may enter a comment and post to the performance network 312. The user can also review all postings in the performance network and provide additional comments, if desired 312. The user may also wish to provide feedback about another user. The user can search for that person 308 to access that user's profile page 310, where the system will display the profile for another user. See FIG. 10, described in greater detail below, for an example user profile screen. The user can them post a message to or about that other user 312. That posting may then be available on that other user's profile page and the corporate group's performance network. The user may also comment on posts that appear on the other user's profile page 312.

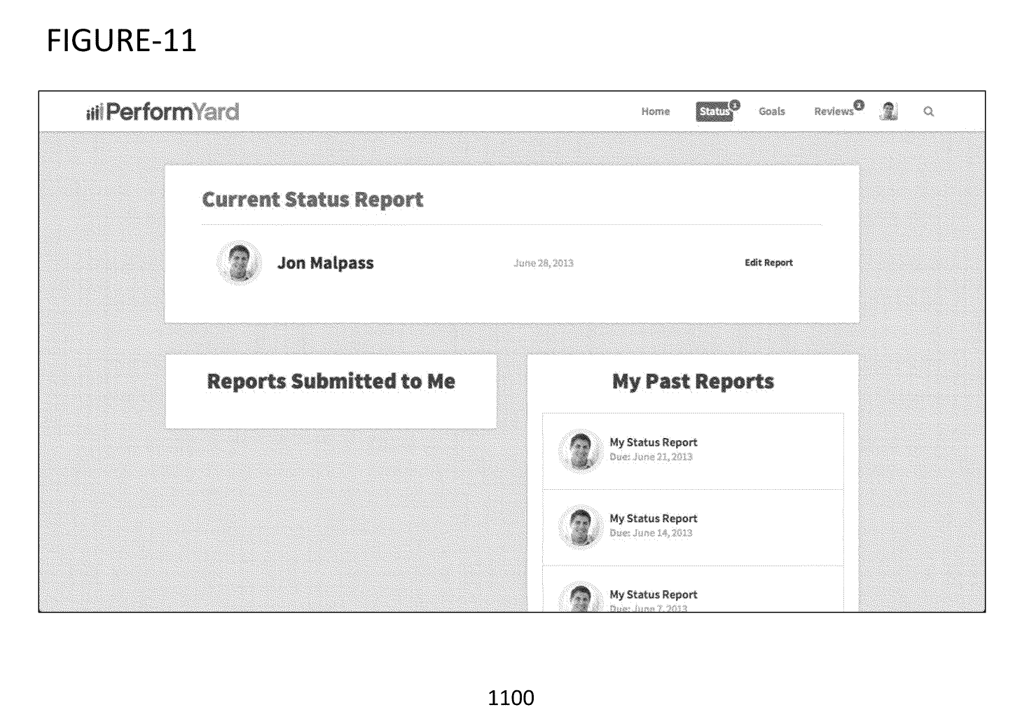

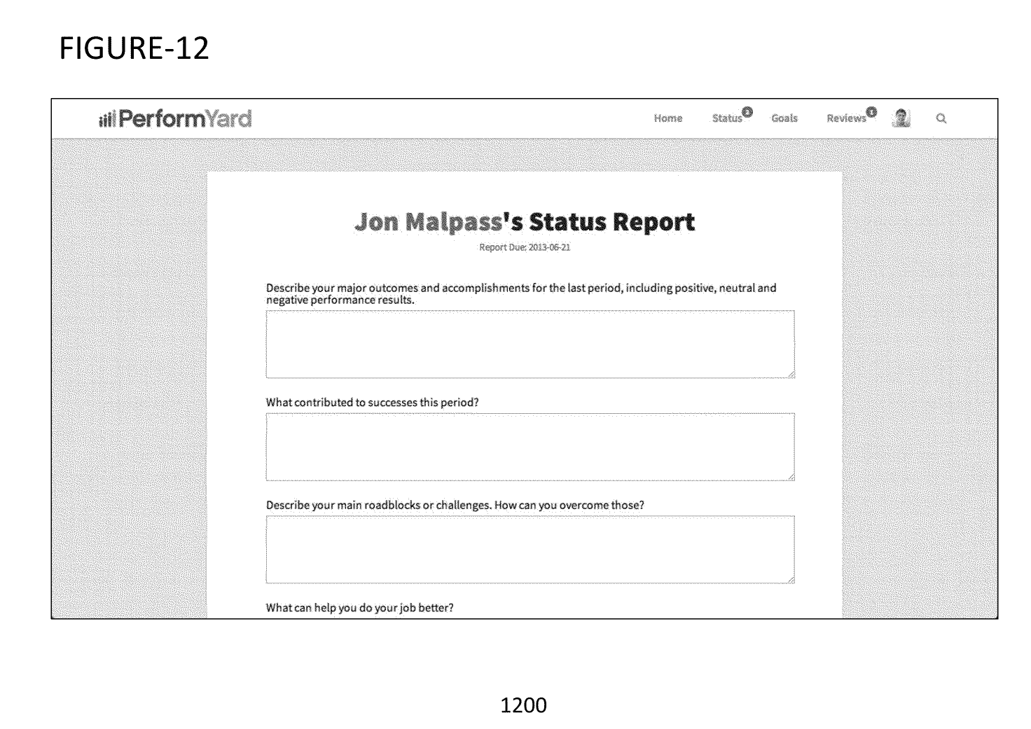

The user may also choose to complete a status report 314. For example, the user may need to complete a weekly status report as part of his/her job, answering a series of update and status questions selected for the corporate group. The user may navigate to the status page and selects the current week's status report to complete. The user answers a series of questions and submits that report to the user's manager (which may be another role defined in the system) 316. The user may also review status reports that have been submitted to him/her or reports that the user has submitted previously 318. See FIG. 11, described in greater detail below, for an example status report screen. Also see FIG. 12, described in greater detail below, for an example status editing screen.

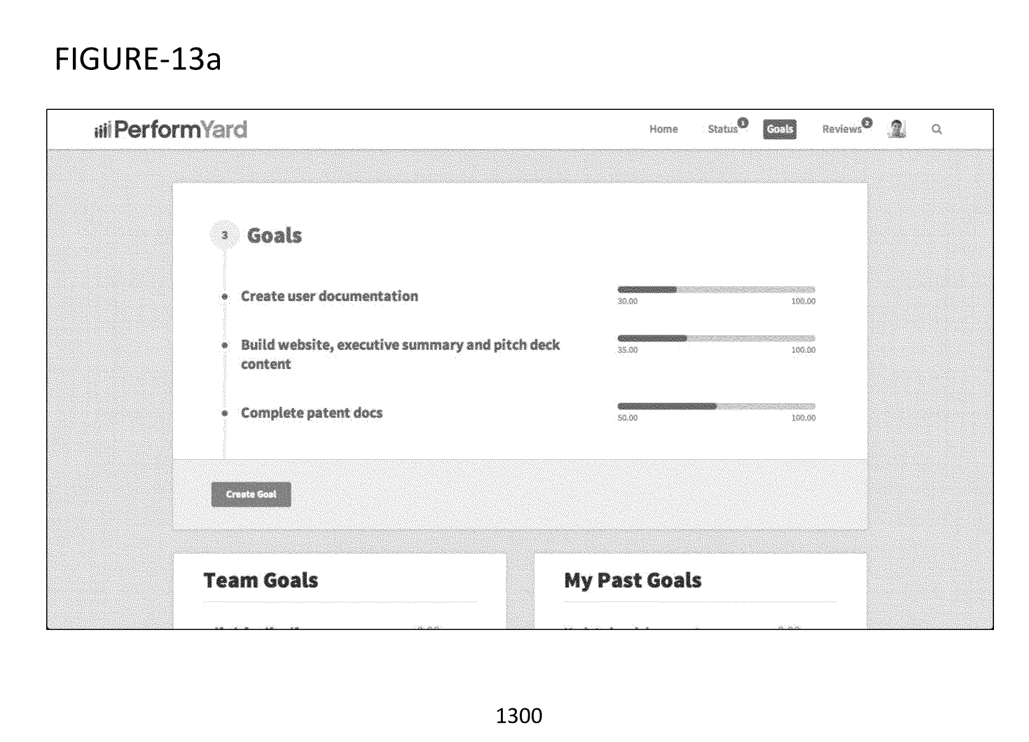

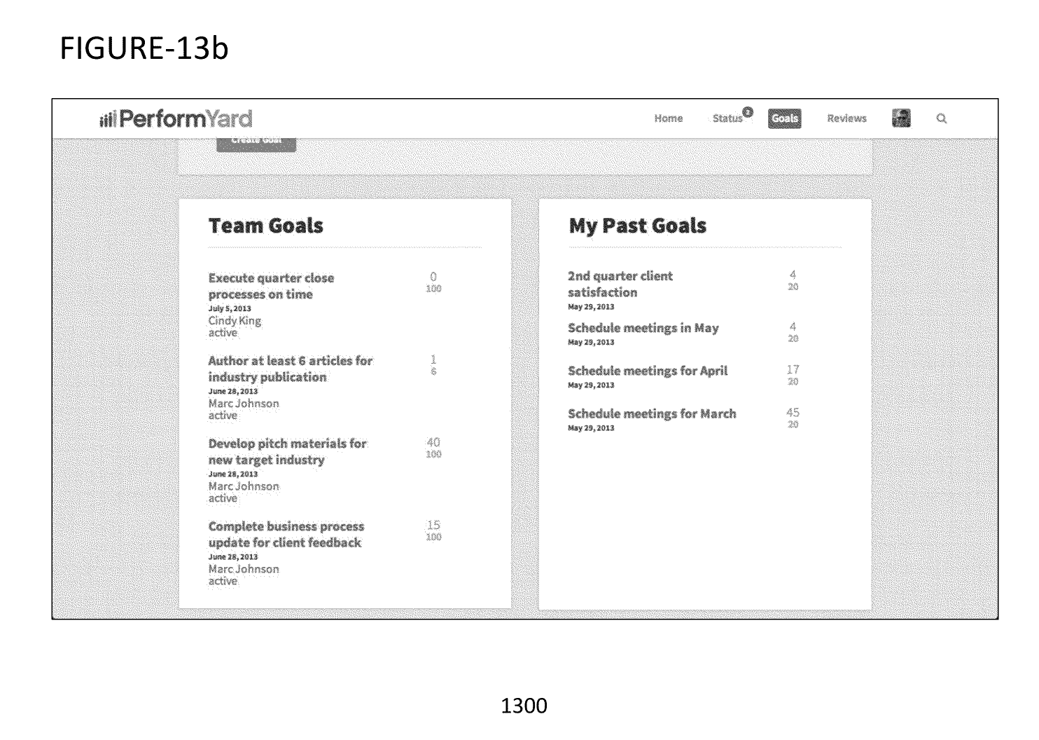

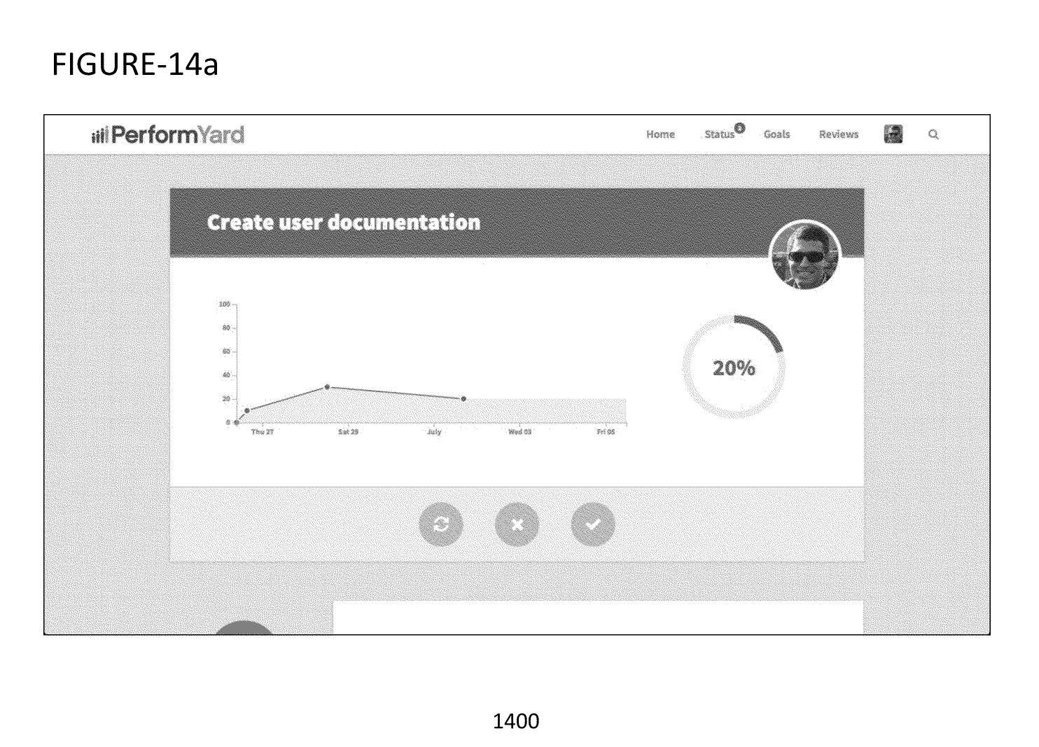

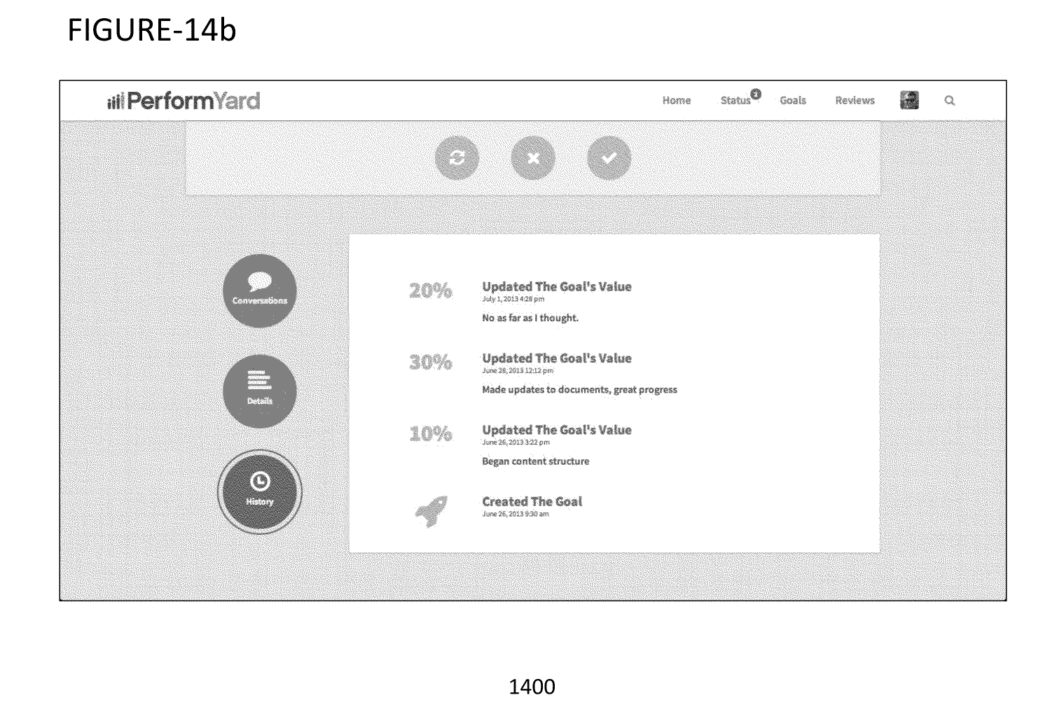

The user may wish to update progress on a specific goal 320. The user may navigate to the goal page and create and/or select the goal to be updated 322. The user may then enter and submit the updated goal information and comments 324. This information can be selected to also appear as a posting in the performance network. A goal may be marked as completed 326, and pending and/or completed goals may be reviewed 328. See FIGS. 13a-13b, described in greater detail below, for an example goal screen. Also see FIGS. 14a-14b, described in greater detail below, for an example goal detail screen.

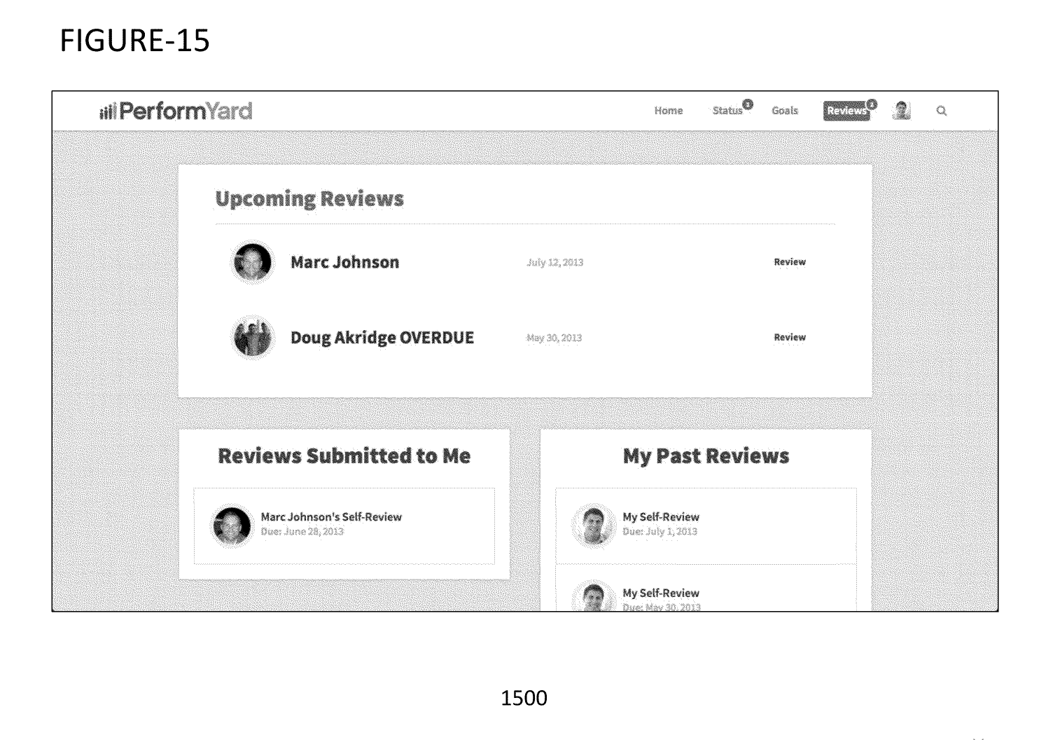

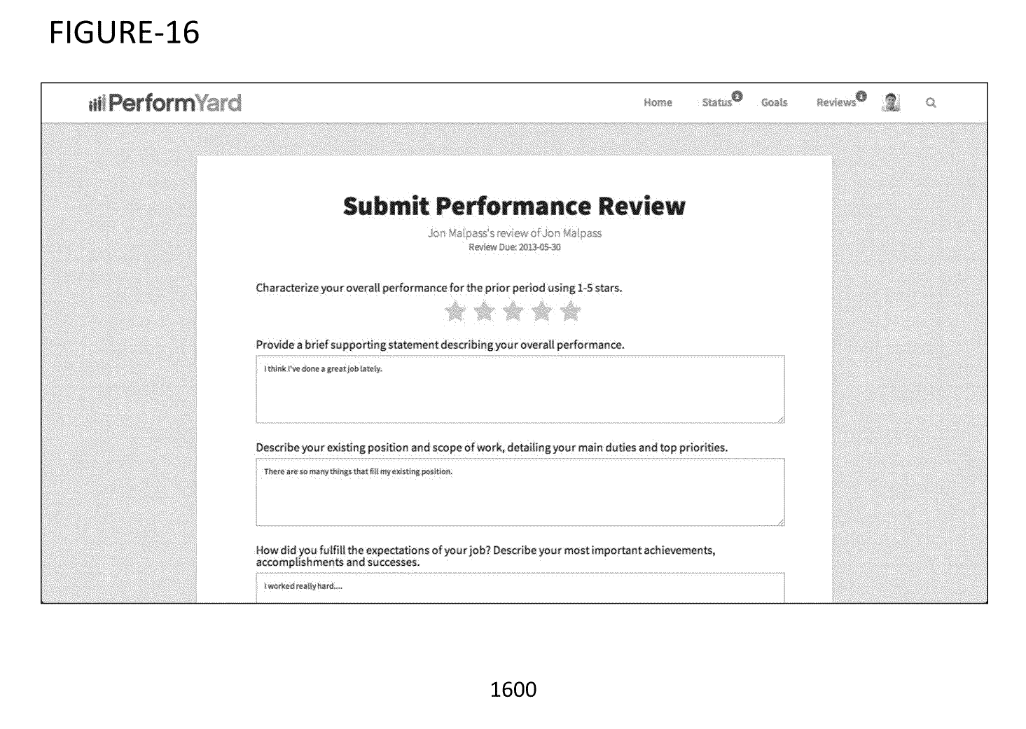

If the user has any reviews to complete, the user may also navigate to the reviews page to locate any reviews about either the user or another user 330, which may be scheduled to be completed by a specified deadline in some examples. The user selects the review to complete and answers a series of questions about the review's subject 332. Upon completing the review, the user can submit that review. The user may also locate and read any past reviews that he/she has completed or that were completed about the user by others 334. See FIG. 15, described in greater detail below, for an example review screen. Also see FIG. 16, described in greater detail below, for an example review editing screen.

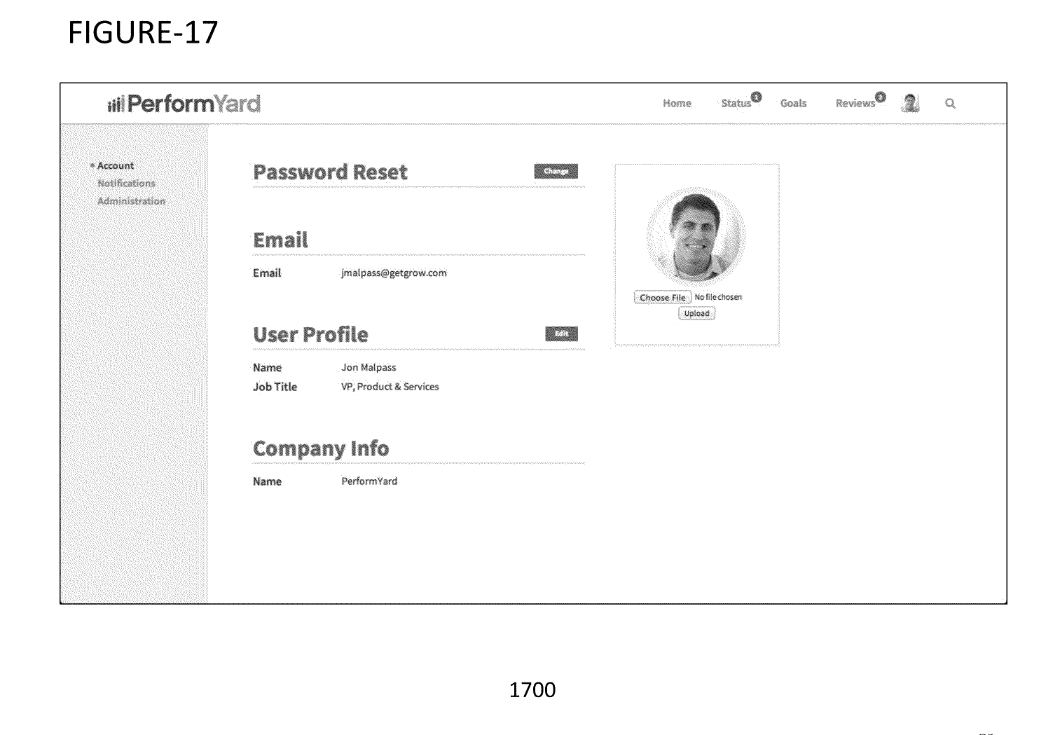

Admin users may be able to navigate to an admin page 336. There, they may be able to manage profiles 338 and/or manage accounts 340, as described in greater detail below. See FIG. 17, described in greater detail below, for an example settings screen which may include admin features in some embodiments.

The user can move at any time between the various tasks and review/add information determined by the user's level of access and role relative to other users. For example, when a user has finished a task, the user may choose another task or choose to end their session 342. When the user has completed activities within the system, the user may log off and exit the session 344.

FIG. 4 is a network interaction process 400 according to an embodiment of the invention. This is an example process depicting in detail how a user may interact with the performance network as described above. The user logs into the corporate performance management system 405; the system may display the user's home page that includes the performance network for the company 410. If the user wants to post a message about him or herself to the network, the user may enter a message into a data entry box on the page and click “Share Message” 415, for example. The system may register that message and then refresh the performance network 420. The system may display the user's posting on the page, along with a timestamp for the message and/or a picture of the user in some embodiments.

The user may review existing users' posts on the performance network 425. After reviewing other postings in the performance network, the user may want to comment on an existing post in the performance network. The user may click a comments button for the posting on which he or she wants to comment 430, for example. The system may return some or all existing comments on that posting 435, for example by expanding the display for that posting to include all existing comments and a data entry box for the user. The user may enter the comment to the posting and click “Add Comment” 440, for example. The system may register the user's comment and refresh the comments list to show the new comment in addition to prior ones 445, along with a timestamp and/or picture of the user in some embodiments. In addition, the system may update the display of the number of comments related to that posting. Once the user is finished, the user may navigate to another part of the corporate performance management system or exit the system 450.

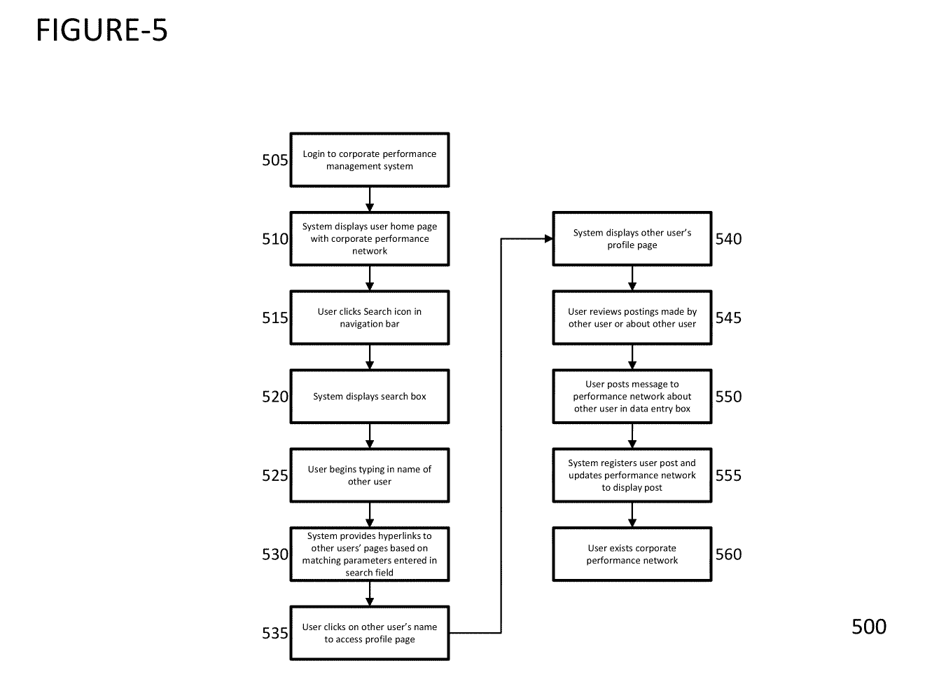

FIG. 5 is a profile interaction process 500 according to an embodiment of the invention. This is an example process providing details about how a user may enter a comment about another user in the performance network as described above. The user may log into the corporate performance management system 505; the system may display the user's home page that includes the performance network for the company 510. The user may navigate to and click the search icon in a navigation bar or elsewhere on the page 515; the system may provide a data entry box 520 where the user can start to type in the name of the other user they are trying to find 525. The system may provide links to other users' pages that match the parameters the user enters into the search box 530, updating dynamically as the user enters in the name in the search box in some embodiments. The user may click on a name of another user 535. The system may display that other user's profile page 540.

The user may review the performance network postings for the other user 545. If the user wants to enter a posting about the other user, the user may enter a message into a data entry box on the page and click “Share Message” 550, for example. The system may register that message and then may refresh the performance network 555. The system may display the user's posting on the page, along with a timestamp for the message, a picture of the user, and a picture of the recipient of the comment in some embodiments. Once the user is finished, the user may navigate to another part of the corporate performance management system or exit the system 560.

FIG. 6 is a status update process 600 according to an embodiment of the invention. This is an example process describing in detail how a user may complete a status report as described above. The user may log into the corporate performance management system 605 and click on status in the navigation bar 610, for example. The system may display the status summary page for the user 615, which may show the user's current status report and any past reports for the user or employees he/she manages. In order to display the appropriate current status report for the user to complete, the system may generate a new status report for the user at the completion of every week or other desired interval.

To complete the status report, the user may click “Edit Report” 620, for example. The system may provide a new page that includes all of the questions in the status report to be completed 625. In doing so, the system may also display any answers to the questions that have been previously saved. Using the data formats determined for the status report, the user may enter answers to the questions 630. If the user has answered some of the questions but is not ready to submit the final status report, the user may click “Save for Later” 635, for example. The system may store the user's answers 640. If the user has completed the status report and wants to submit it, the user may click “Save and Submit” 645, for example. The system may then register those answers and make a report of those answers available to the user's manager 650. The system may then return the user to the status summary page 655. Once the user is finished, the user may navigate to another part of the corporate performance management system or exit the system 660.

FIG. 7 is a goals update process 700 according to an embodiment of the invention. This is an example process flow depicting in detail how a user may provide a status update for an existing professional goal as described above. The user may log into the corporate performance management system 705 and click goals in the navigation bar 710, for example. The system may display the goals summary page for the user 715 that may show all active goals for the user, past goals for the user, and/or goals for employees that the user manages, for example.

The employee may have options to provide a progress update for the goal. From the goals summary page, the user can use a shortcut to provide an update. For example, the user may hover over the goal name or progress bar for the goal. The system may return icons representing the actions the user can take in the shortcut, e.g. complete the goal, edit the goal, archive the goal, and update the goal. The user may click the update icon 720, and the system may return a dialog box that allows the user to enter a new value for progress and a comment 725. After completing the information, the user may click “Update” 730, for example. The system may register the update and refresh the goal summary page to include the new progress in a graphical progress bar 735.

The employee may also access a goal detail page to update progress or engage in a coaching conversation for a goal in addition to viewing historical goal progress, comments, and/or manager/employee coaching. For this route, the user may click on the name of a specific goal 745, for example. The system may display the goal detail page for that goal 750 for the user to review 755. The user may use the same shortcut as previously described to update the goal by clicking the “Update” icon 760, for example. The system may provide data entry boxes 765 into which the user can provide progress information and click “Update” 770, for example. The system may then refresh the goal detail page to include the new progress in the graphical progress depictions and history.

From the goal detail page, the user may also read and enter coaching comments. To do so, the user may enter a coaching comment into an available data entry box and click “Add Comment” 775, for example. The system may refresh the goal detail page to display the new coaching comment in the context of all other coaching comments that he/she has given or that the user's manager has given 780. Once complete, the user can return to the goal summary page 785. Once the user is finished, the user may navigate to another part of the corporate performance management system or exit the system 740.

FIG. 8 is a review completion process 800 according to an embodiment of the invention. This is an example process flow showing details about how a user may complete an employee review as described above. The user may log into the corporate performance management system 805 and click on reviews in the navigation bar 810, for example. The system may display the review summary page for the user 815 which may show all reviews available for the employee to complete, along with any past reviews about the user or employees he/she manages. Based on workflows determined by review dates set by administrators, the system may make reviews available for the employee to complete.

To complete an employee review, the user may click “Review” in the same line as the name and picture of the employee to be reviewed 820, for example. The system may provide a new page that includes all of the questions in the review to be completed 825. In doing so, the system may also display any answers to the questions that have been previously saved. Using the data formats determined for the review, the user may enter answers to the questions 830. If the user has answered some of the questions but is not ready to submit the review, the user may click “Save for Later” 835, for example. The system may store the user's answers 840. If the user has completed the review and wants to submit it, the user may click “Save and Submit” 845, for example. The system may then register those answers and make a report of those answers available to the appropriate users 850. The system may then return the user to the reviews summary page 855. Once the user is finished, the user may navigate to another part of the corporate performance management system or exit the system 860.

Various example screenshots corresponding to the aforementioned processes are described in detail below.

FIG. 9 is a home page screenshot 900 according to an embodiment of the invention. This may be an example home page reached directly after a user logs into the corporate performance management system. This home page may display summary performance information for this user, an employee performance network for all users within the same corporate group, and a navigation menu to provide access to additional features and functions within the system.

The navigation menu may provide access to various functions of the application and may appear on all pages in the system, for example on the top as shown in FIG. 9. The navigation menu may include links to reach a series of pages, including Home, Status, Goals, Reviews, Settings/Administration, and a search function to locate other users within the same corporate group. The navigation menu may also include notifications for pending activities highlighted for the appropriate sections of the application.

The collection of posts by various users in the performance management system may be displayed as shown. This may create an ongoing performance data feed sorted in chronological order that can be reviewed by any user in the corporate group. This data feed may be continually updated as users publish additional performance posts. Since this may result in a significant number of posts, the system may load older postings in batches as a user continues to scroll down the webpage, creating a dynamically updating page of performance network posts.

At the top of the example page 900 is a data entry box where the user can post a message to the performance network about him or herself. This post may include any information the user wishes to add, such as a message about his/her own work performance. These posts may then be visible for others in the corporate group to view, as described above. This posting is one way for users to contribute content into the corporate performance network.

The user may provide comments on any post within the corporate performance network. Where any user has provided a posting (about him/herself or another user), the user may select the comments icon, where the system displays all comments made about that post (if any) for the user to review and a data entry box to allow the user to enter a comment related to the original post. The user may enter and add a comment or choose to cancel the comment rather than enter one.

The performance network may be filterable by the user by selecting and highlighting the “You” icon in the left-hand pane in this example, rather than the “Company” icon. This action may allow the user to restrict the display of performance network posts to only those related to that user (e.g. that the user has provided, feedback the user has received or feedback the user has given to others). At any time the user may select the “Company” icon to update the performance network to display all posts by users in the corporate group.

The summary performance information on the left-hand side of the page 900 in this example may include such details as the employee's goals and other information. For each goal listed, the employee's current progress percentage may appear along with the title of the goal. These goal names may be hyperlinks that take the employee to the goal detail page described below.

FIG. 10 is a user page screenshot 1000 according to an embodiment of the invention. The name of each user in the performance network may be a hyperlink to access the user profile page 1000 for any user within the corporate group. Alternately, a user can reach another user's profile page 1000 by searching for and selecting that other user via the Search functionality in the navigation menu. This user profile page 1000 may provide basic summary information about another user and a filtered set of performance network postings that only display information about that specific user (e.g. that the user whose page is being viewed has submitted or has been provided about that user).

Above the performance network postings in this example is a data entry box where the user can provide comments about or direct feedback to the user whose profile page 1000 is being viewed. This posting may include, for example, specific feedback about that other user or any other content provided by the user that he/she relates to this other user. This posting may then be displayed on this user's performance network posting list and in the corporate performance network available to all users in the corporate group.

Each user profile page 1000 may include the user's name and summary performance information, as shown in the left-hand pane of this example. This performance information may include such details as the user's goals and a summary progress metric. When user with a manager role is viewing the user profile page 1000 for an employee he or she manages, the goal names may be hyperlinks to the goal detail page for that employee's goal as described below.

FIG. 11 is a status report screenshot 1100 according to an embodiment of the invention. For any user, the link to status may bring that user to the summary page for status reports 1100. Status reports 1100 may be regular, documented updates about the user's recent work performance completed by answering a series of questions. These questions may be answered using various data entry means such as text boxes, list entries, or graphical selections, as described above. The system may provide a set of questions to be used in each status report, although administrators of the system can set specific questions for the corporate group in some embodiments.

This example may include main functionality for the user for status reports. The top section of the example page 1100 lists all status reports that need to be completed by the employee. The system may generate a new status report to be completed at the beginning of every new work period based on the pre-set schedule of status reports defined for the corporate group (e.g. weekly or bi-weekly). The status report for the current period may always appear in this section until the due date has passed in some embodiments. If the user does not complete and submit a status report by the due date, that status report, along with any others not previously completed for past work periods, may appear as an overdue status report. For all status reports in the top section, the user can select to edit the status report to complete the questions.

The lower half of the screen 1100 in this example provides access to completed status reports depending on the employee's role. The lower-left section provides all status reports submitted to the user by other users for whom this user is designated as a manager. If the user is designated as a manager, the system may make available individual status reports from those other users for ease of review and action. The lower-right section provides a history of all status reports (“My Past Reports”) that this user has submitted. Each of these sections may display these reports chronologically. Though a limited number of reports may be automatically displayed, the user may load additional past reports as necessary. The user can select any completed status report from either of these sections to be provided with a display of the information provided in that report.

FIG. 12 is a status edit page screenshot 1200 according to an embodiment of the invention. If a user selects to edit a status report, the user may be provided with a new page 1200 that may include the questions required in the status report and space to provide answers depending on the format of the question. The user may complete any or all of the questions, and then either save the status report or submit it when completed. The system may allow multiple different types of questions depending on what kind of answer is sought. For example, question types may include free text, numeric answers, graphical answers, and/or list entry with multiple, individual answers to the same question. These features may allow for easier compilation and action as necessary depending on the content needed.

A user may not need to complete the entire status report in a single instance, but rather can complete some questions, save the report, and return later to edit existing answers and/or complete the remainder of the report. Once a user submits a status report, it may remain in the current status report section until the due date has passed as described above. If a user completes and submits an overdue status report, that report may move immediately into a “My Past Reports” section in some embodiments.

FIGS. 13a-13b are goals page screenshots 1300 according to an embodiment of the invention. The link to Goals on the home page may bring that user to the summary page for managing employment-related goals as depicted in FIGS. 13a-13b. On the goal summary page 1300, a user may establish new goals, provide status updates for existing goals, and/or access detailed information for current or past goals, as well as for goals of employees that the user manages. The system may provide for multiple types of goals depending on how the goal is measured. For example, a numeric target goal may be one where the user is trying to achieve a specific threshold, such as in a salesperson achieving a sales quota. Other goal types may include percentage completion where progress is measured on a scale from zero to 100%.

Current goals may be listed in the top half of the screen, for example, each with a name that is a hyperlink to a detailed page about that goal. On the goal summary page as depicted in FIGS. 13a-13b, each goal may have a graphical representation of current progress, along with shortcut links to complete the goal, delete the goal, and/or update progress on the goal directly from the goal summary page 1300.

As shown in FIG. 13b, the lower-left section of the screen 1300 in this example provides access to current and past goals for each employee that the user manages. These may be listed along with a current progress metric. Hyperlinks may take the user to the detailed description/information page for that goal. The lower-right section of this example may provide all past goals for the user, along with hyperlinks that may take the user to the detailed description/information page for that past goal.

FIGS. 14a-14b are goal detail screenshots 1400 according to an embodiment of the invention. Each goal may have a detailed goal page 1400 that may include summary information about an employee goal. The detailed goal page 1400 may include a history graph depicting employee progress at achieving this goal since its inception as shown in FIG. 14a and/or a current completion percentage as shown in FIG. 14b. These dynamic graphics may update over time and as the employee updates progress for each goal. The history graph may begin when the goal is created, may include data points for each progress update the employee has made, and may continue through the current date/time for easy review and understanding of the amount of progress made and when. The goal detail page 1400 may also include the goal description information and a detailed history of progress updates that have been made to the goal. The goal detail page 1400 may also include a place for a user and his/her manager to conduct and record a coaching conversation about the goal.

Goals can be updated at any time by the user using the shortcuts that appear on this page. These shortcuts may allow the employee to update progress, complete the goal, delete the goal, and/or edit the goal's title or description in the same manner as those shortcuts on the goal summary page 1300.

The goal detail page 1400 may also include options for a manager and an employee to have an interactive coaching conversation about the goal and the employee's progress. For example, a manager may have constructive suggestions on how to achieve this goal and may want to document these coaching tips for the employee. The employee may then respond to these messages, creating a dynamic conversation captured and displayed by the system. Further, this back and forth interaction may be privacy limited to only those users that have access to view the goal detail page 1400.

When a user creates a goal or completes a goal, that action may be published by default to the performance network. When published to the performance network, that information may appear as a posting in the corporate performance network and on the individual user's profile page. In both cases other users may be able to add comments about the posting, such as congratulatory comments when an employee has achieved success with regard to a goal.

FIG. 15 is a review page screenshot 1500 according to an embodiment of the invention. The link to reviews on the home page 900 may bring the user to the summary page for employee reviews 1500. This page may include functionality for the user with regard to completing and reviewing employee performance evaluations. The top section of the screen in this example 1500 lists the current reviews to be completed by the user. Current reviews may be those not yet completed by the user with an upcoming deadline assigned by an administrator. These reviews may include a self-evaluation to be completed by the user about him or herself, a review to be completed by the user about an employee that the user manages, or any additional reviews that the user may be asked to complete about another employee.

As a review deadline approaches, the system may create a review form for both employee and manager to complete according to a template defined for the corporate group. At a specified time before the due date, reviews may be made available for completion in the current review list.

The lower half of the screen in this example 1500 provides access to completed reviews depending on the employee's role. The lower-left section, for example, may provide all reviews submitted by or about other employees for whom the user is designated as a manager. The lower-right section, for example, may provide a history of all reviews about this user, either by the user about him/herself or about the user by another user. The user can select any completed review to be provided with a display of the information completed in that review.

FIG. 16 is a review edit page screenshot 1600 according to an embodiment of the invention. For all reviews that have not yet been completed, the user can select to edit the review and answer the appropriate questions. Upon selecting to edit a review, the user may be provided with a new page 1600 that includes the questions required in the review and space to provide answers depending on the format of the question. The system may allow multiple different types of questions depending on what kind of answer is sought. For example, question types may include free text, numeric answers, graphical answers, and/or list entry with multiple, individual answers to the same question.

The user may complete any or all of the questions, and then either save the review to be completed later or submit it when finished. A user may not need to complete the entire review in a single instance, but rather may complete some questions, save the review, and return later to edit existing answers and/or complete the remainder of the review, as described above.

FIG. 17 is a settings page screenshot 1700 according to an embodiment of the invention. To engage in the performance network or any of the other features in the system, each user may complete and maintain a personal profile in the settings section 1700. The settings section 1700 may allow the user to maintain a profile picture that is displayed along with their name on various pages in the system and manage pertinent information such as name, title, job description, role, etc.

Administrators of the system may also use this area to manage accounts of each user in the corporate group. This administration may include identifying the appropriate manager for each employee (the manager being the user that receives another user's status report and that completes another user's review) and setting an appropriate review due date, which may trigger the availability of and notifications for reviews to be completed as described above. Administrators also may have the responsibility to maintain billing and payment information for the corporate performance system in some embodiments, in addition to responsibilities for creating or deactivating user accounts. Administrators may also be responsible for managing the templates used in the corporate group for status reports and reviews. While the system may be initially populated with template formats for these features, the templates may be modified by the administrator, for example by writing questions to be included in each report along with selecting the format for user responses, which may include long answer text boxes, list answers, starred questions, and/or numerical answers.

As described above, users may receive notifications in the navigation bar. These notifications may alert the user to a specific activity, event, or deadline. An example of a notification is one where the user has a review to be completed. The notification may appear when the review is available to be completed. Once the user has completed the review activity, the notification may disappear.

Through the use of the systems and methods described above, integration of corporate performance functions may be achieved. For example, the aforementioned performance network, status reporting, goal management, and review administration may all be accessible via the system. The corporate performance network may enable postings and comments open to all employees within an organization that may provide visibility into work, accomplishments, and goals. A dynamic system to prompt users for status report completion with automatic creation of a new report every time period (e.g. weekly) may be provided based on a corporate template with workflows to submit reports for acknowledgement/approval and commenting. Workflows and progress depictions for managers/employees to oversee multiple types of goals may be provided, with integration of formal performance coaching and linkage of goal management/achievement to a social performance network. Integration of recurring performance evaluations (reviews) with work activities/achievements documented may be achieved by the performance network, goal management, and status reports.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A performance management system comprising:
a processor circuit;
a database in communication with the processor circuit;
a performance network module in communication with the processor circuit and the database, the performance network module configured to:
receive a post from a user and cause the post to be displayed on a display; and
receive a comment associated with the post from the user and cause the post to be displayed on the display;
a report module in communication with the processor circuit and the database, the report module configured to:
generate a report including a question and send the report to the user; and
receive an answer to the question in the report from the user and store the answer in the database;
a goal module in communication with the processor circuit and the database, the goal module configured to:
receive a goal and/or an update to the goal; and
update a status associated with the goal; and
a review module in communication with the processor circuit and the database, the review module configured to:
generate a review including a question and send the review to the user; and
receive an answer to the question in the review from the user and store the answer in the database.

2. The performance management system of claim 1, wherein the processor circuit is in communication with a network.

3. The performance management system of claim 2, wherein the post, the comment, the answer to the question in the report, the goal, the update to the goal, and/or the answer to the question in the review are received via the network.

4. The performance management system of claim 1, wherein the performance network module is further configured to cause the post and/or the comment to be displayed on a plurality of displays associated with a plurality of users.

5. The performance management system of claim 1, wherein the question in the report comprises a question about a user's work performance.

6. The performance management system of claim 1, wherein the report module is further configured to generate the report and send the report to the user at regular intervals.

7. The performance management system of claim 1, wherein the goal module is further configured to generate a goal status report and cause the goal status report to be displayed on the display.

8. The performance management system of claim 1, wherein the question in the review comprises a question about an employee's work performance.

9. The performance management system of claim 1, wherein the review module is further configured to generate the review and send the review to the user at regular intervals.

10. The performance management system of claim 1, further comprising a profile module in communication with the processor circuit, the profile module being configured to:
receive a selection of an employee profile from the user and cause the employee profile to be displayed on the display; and
receive a post associated with the employee profile from the user and cause the post to be displayed on a display along with the employee profile.

11. The performance management system of claim 1, further comprising a settings module in communication with the processor circuit, the settings module being configured to:
create an employee profile and store the employee profile in the database; and
receive a modification of the employee profile from the user and store the modification in the database.

12. The performance management system of claim 11, wherein:
the employee profile comprises an identification of a user designated to receive the review associated with the employee profile;
the employee profile comprises a time for generating the report associated with the employee profile; and
the modification of the employee profile is received from a user designated as an administrator.

13. A performance management method comprising:
receiving, with a performance network module in communication with a processor circuit, a post from a user and causing the post to be displayed on a display;
receiving, with the performance network module, a comment associated with the post from the user and causing the post to be displayed on the display;
generating, with a report module in communication with the processor, a report including a question and sending the report to the user;
receiving, with the report module, an answer to the question in the report from the user and storing the answer in a database in communication with the processor circuit;
receiving, with a goal module in communication with the processor circuit, a goal and/or an update to the goal;
updating, with the goal module, a status associated with the goal;
generating, with a review module in communication with the processor circuit, a review including a question and sending the review to the user; and
receiving, with the review module, an answer to the question in the review from the user and storing the answer in the database.

14. The performance management method of claim 13, wherein the processor circuit is in communication with a network.

15. The performance management method of claim 14, wherein the post, the comment, the answer to the question in the report, the goal, the update to the goal, and/or the answer to the question in the review are received via the network.

16. The performance management method of claim 13, further comprising causing, with the performance network module, the post and/or the comment to be displayed on a plurality of displays associated with a plurality of users.

17. The performance management method of claim 13, wherein the question in the report comprises a question about a user's work performance.

18. The performance management method of claim 13, further comprising generating, with the report module, the report and sending the report to the user at regular intervals.

19. The performance management method of claim 13, further comprising generating, with the goal module, a goal status report and causing the goal status report to be displayed on the display.

20. The performance management method of claim 13, wherein the question in the review comprises a question about an employee's work performance.

21. The performance management method of claim 13, further comprising generating, with the review module, the review and sending the review to the user at regular intervals.

22. The performance management method of claim 13, further comprising:
receiving, with a profile module in communication with the processor circuit, a selection of an employee profile from the user and causing the employee profile to be displayed on the display; and
receiving, with the profile module, a post associated with the employee profile from the user and causing the post to be displayed on a display along with the employee profile.

23. The performance management method of claim 13, further comprising:
creating, with a settings module in communication with the processor circuit, an employee profile and storing the employee profile in the database; and
receiving, with the settings module, a modification of the employee profile from the user and storing the modification in the database.

24. The performance management method of claim 23, wherein:
the employee profile comprises an identification of a user designated to receive the review associated with the employee profile;
the employee profile comprises a time for generating the report associated with the employee profile; and
the modification of the employee profile is received from a user designated as an administrator.
